(19) United States
(12) Patent Application Publication
(10) Pub. No.: US 2017/0357698 A1
(43) Pub. Date: Dec. 14, 2017

(54) NAVIGATING AN ELECTRONIC ITEM DATABASE VIA USER INTENTION

(71) Applicant: Amazon Technologies, Inc., Seattle, WA (US)

(72) Inventors: Joy Yuzi Chang, Seattle, WA (US); Karthik Gopal Anbalagan, Mercer Island, WA (US); Brian Joseph Collins, Woodinville, WA (US); Lindsey Christina Fowler, Seattle, WA (US); Eric Vincent Hansen, Cle Elum, WA (US); Jennifer Marie Lin, Seattle, WA (US); Joshua Kenneth Pschorr, Seattle, WA (US)

(21) Appl. No.: 15/181,120

(22) Filed: Jun. 13, 2016

(51) Int. Cl. G06F 17/30; G06F 3/0482; G06F 3/0484

(52) U.S. Cl. CPC G06F 17/30554; G06F 17/30528; G06F 3/04842; G06F 17/30867; G06F 3/0482; G06F 17/30395

(57) ABSTRACT

Disclosed are various embodiments for navigating an electronic item database by way of a user intention. A user interface is generated that presents a first result set of items from an electronic item database. The user interface includes one or more user interface components configured to elicit a user selection from multiple user intentions. A particular user intention is determined, then a set of refinement attributes corresponding to the particular user intention is identified. An updated result set of items that matches the set of refinement attributes is determined. The user interface is then updated to present the updated result set of items in place of the result set of items.

### BACKGROUND

Typically, users may search through an electronic item database by specifying a search query formed of keywords. The search engine will then locate items that match the search query in some respect, e.g., the keywords may be contained in an item title or description. The items returned by the search engine may be ranked based on relevance to the search query. For example, an item matching the keywords in the title may be a better match than an item merely matching the keywords in the description. Similarly, an item having more occurrences of the keywords in the description may be ranked higher than an item with fewer occurrences of the keywords.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A and 1B are pictorial diagrams of example user interfaces according to various embodiments.

FIG. 2 is a schematic block diagram of a networked environment according to various embodiments of the present disclosure.

FIGS. 3A-3C are pictorial diagrams of example user interfaces rendered by a client device in the networked environment of FIG. 2 according to various embodiments of the present disclosure.

FIGS. 4A-4D are pictorial diagrams of alternative example user interfaces rendered by a client device in the networked environment of FIG. 2 according to various embodiments of the present disclosure.

FIG. 5 is a flowchart illustrating examples of functionality implemented as portions of an item search and navigation application executed in a computing environment in the networked environment of FIG. 2 according to various embodiments of the present disclosure.

FIG. 6 is a schematic block diagram that provides one example illustration of a computing environment employed in the networked environment of FIG. 2 according to various embodiments of the present disclosure.

### DETAILED DESCRIPTION

The present disclosure relates to navigating an electronic item database based on an intention specified by the user. It may be difficult for a user to form an effective search query when searching for items in an electronic item database. A concise search query may broadly result in an unmanageably large result set of items. With large result sets, users may have to peruse numerous pages in order to find a desired item. Numerous items may match the broad search query but may not be relevant to how the user wishes to use the item. Unfortunately, the user may not have enough subject-specific knowledge in order to add limiting keywords in a productive way.

Electronic search interfaces may provide refinement tools in order for the user to select or deselect specific attributes that items in the result set must match. For example, where items are available in different colors, a color refinement tool may allow a user to specify one or more color attributes that the resulting items must match. Consequently, a user is able to refine or limit the scope of the search, thereby reducing the result set of items to a smaller quantity.

Nonetheless, with many types of items, particularly items of a technical nature, it may be difficult for a user to know which refinement attributes are important. That is, a user may not know, or may not have the particular expertise to know, which refinement tools should be used, and moreover, which potential attributes should be selected or deselected. Such an item navigation experience can frustrate users, who may then turn to a sales associate or a technical expert at a brick-and-mortar analogue in order to locate a desired item.

Various embodiments of the present disclosure leverage a user's intention with respect to an item in order to navigate an electronic item database. Specifically, user intention can be used to limit a result set of items by preselecting, in an electronic search interface, a collection of refinement attributes that pertain to the user intention. A subset of the available refinement tools may be utilized, as some refinement tools may pertain to characteristics that are irrelevant to the user intention. Users may specify their intention by answering one or more questions featured prominently in the electronic search interface. Upon the user answering the question(s), the refinement tools may be updated to show which attributes are preselected, and an updated result set of items may be rendered.

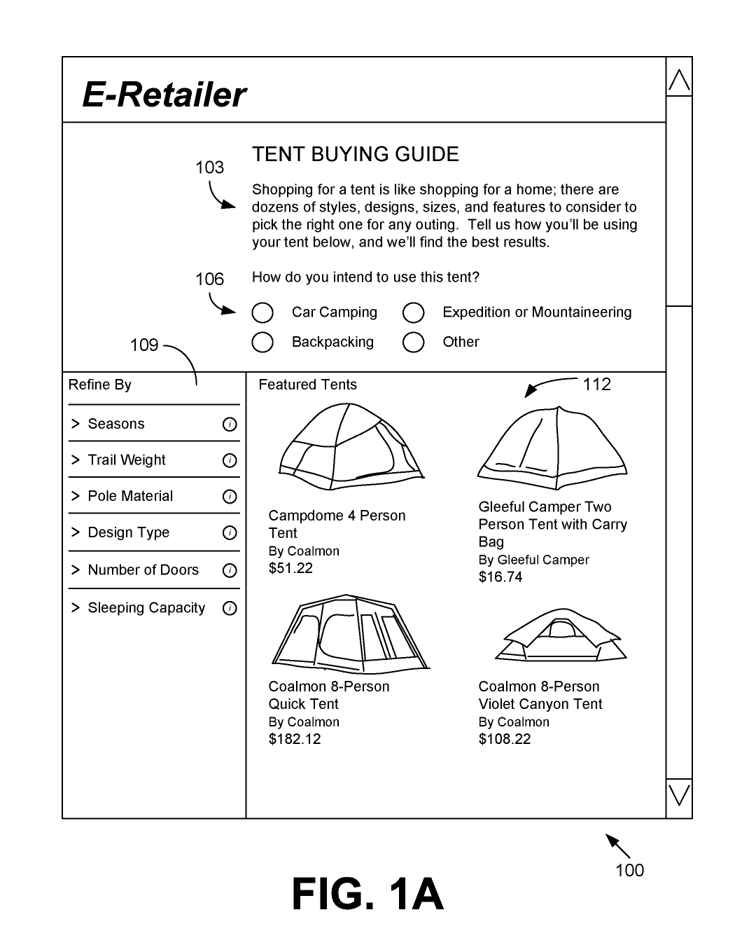

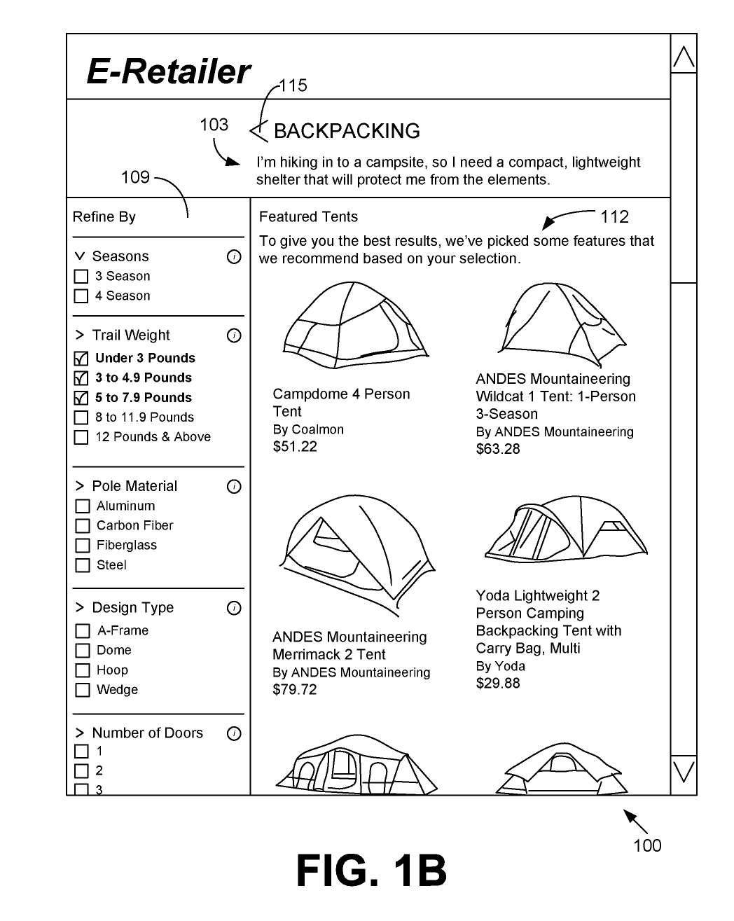

Turning to FIG. 1A, shown is one example of a user interface 100 corresponding to an electronic search interface rendered by a browser. In particular, the user interface 100 presents an electronic search interface for items that are tents. For example, a user may have entered a search query for “tents” or may have navigated to a category of “tents” in an item classification tree. The user interface 100 includes some explanatory text 103 that acts as an introduction to one or more questions directed at ascertaining the user's intention. Here, the explanatory text 103 asks the user—“how do you intend to use this tent?”

Several user interface components 106 below the explanatory text 103 elicit the user intention, thereby allowing the user to specify an intention. In this example, the options provided are “car camping,” “backpacking,” “expedition or mountaineering,” and “other.” When a user selects a particular user intention via the user interface components 106, the user interface 100 is dynamically updated to feature items that are most relevant to the user's intention. In this example, the user interface components 106 are radio buttons, but other user interface components such as checkboxes, drop-down boxes, sliders, hyperlinks, selectable images, etc., may be used in other embodiments.

The user interface 100 also includes several refinement tools 109. The refinement tools 109 allow a user to specify certain refinement attributes that the items should match in order to be shown. The types of refinement attributes that are selectable within the refinement tools may depend on associated attributes within an item classification tree. In this example, the available refinement tools 109 allow for specification of attributes relating to “seasons,” “trail weight,” “pole material,” “design type,” “number of doors,” and “sleeping capacity.” These types of attributes are mostly specific to tents, so it is understood that different attributes may be shown for items that are generators, sleeping bags, backpacks, etc., for example.

The item display area 112 shows a selection of items from the electronic item database that match the search query. In addition, the result set of items may be filtered or ranked based at least in part on item title length, user feedback or review rating, or other attributes. Such attributes may be employed to present the user the most significant results out of the result set, rather than simply all items that match the keywords of the search query. The item display area 112 may be scrollable or paginated in order to accommodate a large quantity of items in a result set. Selecting any item in the item display area 112 may cause a detail page user interface to be rendered with additional information specific to the selected item. The item display area 112 may show item title, item manufacturer, item price, user rating, number of offers, or other information about the respective items.

Moving on to FIG. 1B, the user interface 100 has been updated according to a user intention of “backpacking,” as specified via the user interface components 106 (FIG. 1A). The explanatory text 103 has been updated to introduce the results corresponding to the selected user intention of “backpacking.” One or more user interface components (e.g., the back arrow 115) may allow the user to return to specify a different user intention.

The item display area 112 has been dynamically updated according to the selected user intention to show a subset of the result set of items or a different result set of items. The items shown may be the same result set or may be ranked in a different order. A new result set may be specifically chosen as matching a set of refinement attributes corresponding to the selected user intention. As shown in the expanded refinement tools 109, certain refinement attributes are automatically specified when the user intention of “backpacking” is selected. For example, under the “trail weight” refinement tool, the attributes of “under 3 pounds,” “3 to 4.9 pounds,” and “5 to 7.9 pounds” are automatically selected, and these attributes are emphasized in the user interface 100. Here, emphasizing corresponds to bold text, but italics, color, underlining, etc., may be used with emphasized text in other embodiments.

Notably, “8 to 11.9 pounds” and “12 pounds & above” are not selected in the refinement tools 109. This is because, for the user intention of backpacking, it is desirable to have a tent that is under eight pounds as it must be carried for a long distance. A user could choose to manually select this combination of refinement attributes, but in many areas involving technical items, users do not know the best combinations of attributes for searching an electronic item database.

Accordingly, combinations of attributes may be preselected using various approaches. In a first approach, a combination of attributes corresponding to a user intention may be manually curated by, for example, technical experts, popular critics, popular designers, editors, or others who may have the judgment to pair particular selections of item attributes with user intentions. In a second approach, determining combinations of attributes may be automated over time by soliciting intent data from users and tracking user selections of attributes over time to refine a machine learning model. In a third approach, keywords signaling user intentions regarding an item may be identified from user reviews of the item, and a combination of attributes may be extracted as the attributes in common from the items ordered to fulfill the same user intention. Further, rather than selecting a combination of attributes to refine a previous search, some embodiments may utilize a predetermined change to a particular browse node in an item classification tree or a change of keywords for an item search.

Also, a user could choose to select other attributes or deselect one or more of the selected attributes, and the item display area 112 will be dynamically updated again to show a different result set of items. However, in various embodiments, the same automatically selected refinement attributes will remain emphasized in the user interface 100 despite being deselected, as long as the user intention remains active, in order to remind the user which attributes were recommended according to the user intention. For example, if the user were to select “3 season” under “seasons,” the item display area 112 would be updated to show only those tents that are also three-season tents, but the “3 season” attribute will not be emphasized. Conversely, if the user were to deselect the “5 to 7.9 pounds” attribute, the item display area 112 would be updated to exclude tents over 4.9 pounds, yet the “5 to 7.9 pounds” attributes would remain emphasized as bolded text. In the following discussion, a general description of the system and its components is provided, followed by a discussion of the operation of the same.

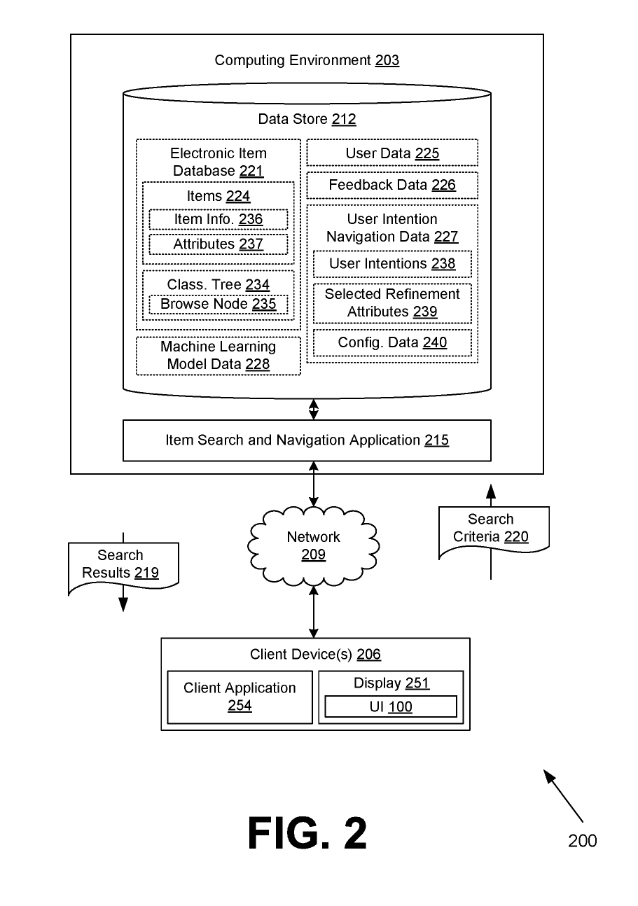

With reference to FIG. 2, shown is a networked environment 200 according to various embodiments. The networked environment 200 includes a computing environment 203 and one or more client devices 206, which are in data communication with each other via a network 209. The network 209 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 203 may comprise, for example, a server computer or any other system providing computing capability. Alternatively, the computing environment 203 may employ a plurality of computing devices that may be arranged, for example, in one or more server banks, computer banks, or other arrangements. Such computing devices may be located in a single installation or may be distributed among many different geographical locations. For example, the computing environment 203 may include a plurality of computing devices that together may comprise a hosted computing resource, a grid computing resource, and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 212 that is accessible to the computing environment 203. The data store 212 may be representative of a plurality of data stores 212 as can be appreciated. The data stored in the data store 212, for example, is associated with the operation of the various applications and/or functional entities described below.

The components executed on the computing environment 203, for example, include an item search and navigation application 215 and other applications, services, processes, systems, engines, or functionality not discussed in detail herein. The item search and navigation application 215 is executed in order to facilitate the online selection of items over the network 209. The item search and navigation application 215 may perform various backend functions associated with an electronic marketplace in order to facilitate the online selection of items as will be described. For example, the item search and navigation application 215 may generate network pages such as web pages or other types of network content that are provided to client devices 206 for the purposes of selecting items for purchase, rental, download, lease, or other form of consumption as will be described.

The item search and navigation application 215 may also generate search results 219 in response to receiving search criteria 220 from a client device 206 over the network 209. To this end, the item search and navigation application 215 is configured to search an electronic item database 221 for items 224 that are associated with data that matches the search criteria 220. The item search and navigation application 215 may apply one or more refinements received from the client device 206 or stored in connection with a user profile in order to filter or limit the search results 219. The generated search results 219 may be included within a search result listing that is returned to the client device 206 for rendering in a user interface. In addition, for certain types of items or search queries, the item search and navigation application 215 is configured to facilitate navigation by way of user intention, whereby a user specifies an intention with respect to a desired item, and refinement attributes are selected automatically on behalf of the user.

The data stored in the data store 212 includes, for example, an electronic item database 221, user data 225, feedback data 226, user intention navigation data 227, machine learning model data 228, and potentially other data. The electronic item database 221 includes information about a plurality of items 224 offered by one or more sellers in an electronic marketplace facilitated by the item search and navigation application 215. As used herein, the term “item” may refer to products, goods, services, downloads, and/or any other item that may be offered for sale, lease, rental, or other forms of consumption.

In some cases, the items 224 may be organized within the electronic item database 221 into an item classification tree 234 (or taxonomy) of categories to facilitate browsing, which may be represented, for example, by a tree structure composed of browse nodes 235. As a non-limiting example, a browse node 235 may correspond to “Crafts” with multiple child browse nodes 235 such as “Jewelry” and “Home Decor.” An item 224 may be associated with one or more such browse nodes 235.

Each item 224 may be associated with item information 236, attributes 237, and/or other data. In some cases, an item 224 may be offered by multiple sellers in an electronic marketplace. The item information 236 may include title, description, weight, images, shipping classifications, user reviews, videos, and/or other information that may be used to describe an item 224. The item attributes 237 correspond to metadata about the item 224 that allow for location of the item 224 by way of refinement tools 109 (FIGS. 1A & 1B). The attributes 237 may be specified in a standardized way so as to allow for comparison and contrast of different items 224 across one or more attributes 237. The attributes 237 may be specific to the type or category of item 224.

The user data 225 may include various data about users of the electronic marketplace, including profile information, personalization information, demographic information, browsing history, order history, previous purchasing habits, and so on. The user data 225 may be used, in particular, by the item search and navigation application 215 to personalize search results 219 for a user. This may involve including or excluding particular items 224 in search results 219 or applying a user-specific ordering to the search results 219 based at least in part on relevance of the particular items 224 to the profile information of the specific user. For example, if a user has ordered a specific brand of tents in the past, tents associated with that brand may be ranked higher in the search results 219.

The feedback data 226 corresponds to various forms of user feedback about items 224. This can include textual reviews of items 224 and ratings of items 224. Items 224 may be given overall ratings by users (e.g., 3.5 out of 5 stars), and/or the ratings may be given across specific dimensions (e.g., manufacturer packaging or ease of use). The ratings provided by individual users may be averaged or combined to determine a composite rating across all users.

The user intention navigation data 227 includes various data that enables providing search results 219 not only based upon conventional search criteria 220 such as a keyword search query but also based upon a user intention 238. A user intention 238 corresponds to what the user intends with respect to a desired item 224. In some examples, this may correspond to a use case, or how the user intends to use the item 224. In other examples, this may correspond to a desired result or what the user seeks to be accomplished by the item 224, particularly where the item 224 is a service. The user intentions 238 may be configured manually or by way of an automated discovery process as will be described.

The user intention navigation data 227 associates the user intentions 238 with selected refinement attributes 239 corresponding to the user intentions 238. Certain types of items 224 may be more applicable to a given use case than other types of items 224. The selected refinement attributes 239 are selected based upon attributes 237 in common of items 224 that are applicable to a use case or user intention 238. In various embodiments, the selected refinement attributes 239 may be preconfigured for a given user intention 238 or may be determined through an automated discovery process for a user intention 238 as will be described. In some embodiments, preselected keywords for an item search or preselected browse nodes 235 for an item classification tree 234 may be employed in lieu of selected refinement attributes 239 for an item search following specification of a user intention 238.

The user intention navigation data 227 may also include configuration data 240 that configures the user experience for navigation using intention. In particular, the configuration data 240 may include explanatory text and code for user interface elements that elicit the intention of the user. For example, the configuration data 240 may configure a series of one or more questions that elicit the user's intention. Further, the configuration data 240 may include various thresholds and parameters that can be used for filtering a result set of items 224 for relevance. For example, the configuration data 240 may configure the result set to be filtered to exclude (or rank lower) items 224 with very long item titles, items 224 that are associated with a relatively low user feedback rating, or items 224 with relatively few orders.

The machine learning model data 228 may correspond to data for one or more machine learning models used to ascertain for which types of items 224 that intention-based navigation should be used, which user intentions 238 should be options, and which selected refinement attributes 239 should be associated with the user intentions 238. In this regard, a feedback model may be employed to determine effectiveness of the navigation, with an order or another type of user interaction being considered a successful outcome, while a lack of an order may be considered an unsuccessful outcome. Additional user intentions may be learned from the users (e.g., a user may be able to specify his or her intention via freeform text). Machine learning models may also be used in some cases to ascertain categories of attributes that are to be the basis of refinement tools 109 (FIG. 1A), such as “Seasons,” “Trail Weight,” etc., as shown in the example of FIG. 1A.

The client device 206 is representative of a plurality of client devices that may be coupled to the network 209. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client device 206 may include a display 251. The display 251 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 254 and/or other applications. The client application 254 may be executed in a client device 206, for example, to access network content served up by the computing environment 203 and/or other servers, thereby rendering a user interface 100 on the display 251. To this end, the client application 254 may comprise, for example, a browser, a dedicated application, etc., and the user interface 100 may comprise a network page, an application screen, etc. The client device 206 may be configured to execute applications beyond the client application 254 such as, for example, email applications, social networking applications, word processors, spreadsheets, and/or other applications.

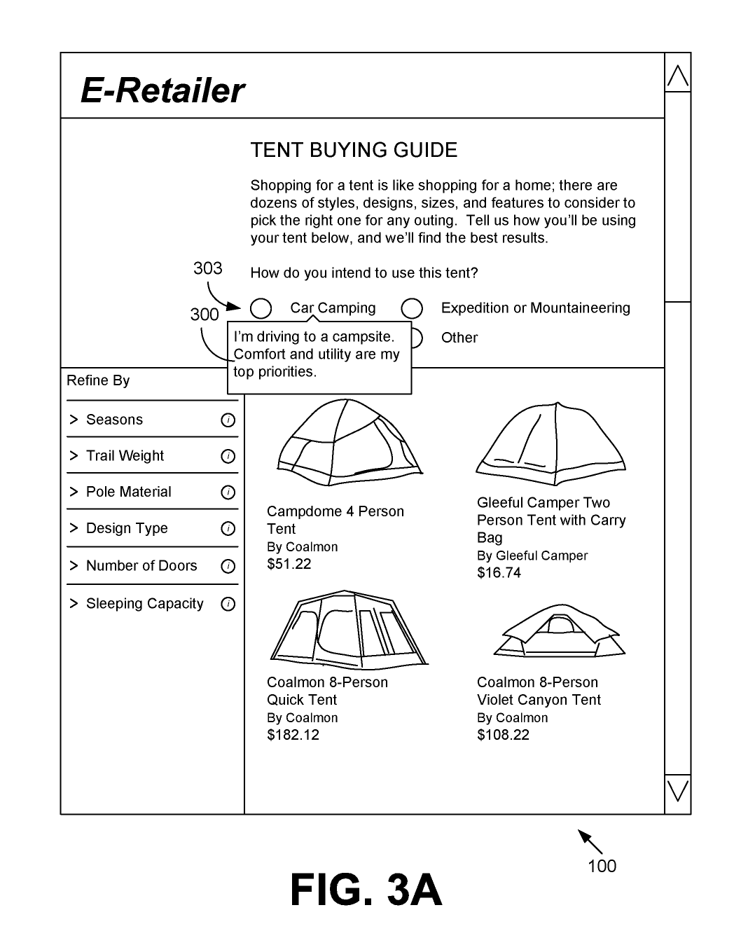

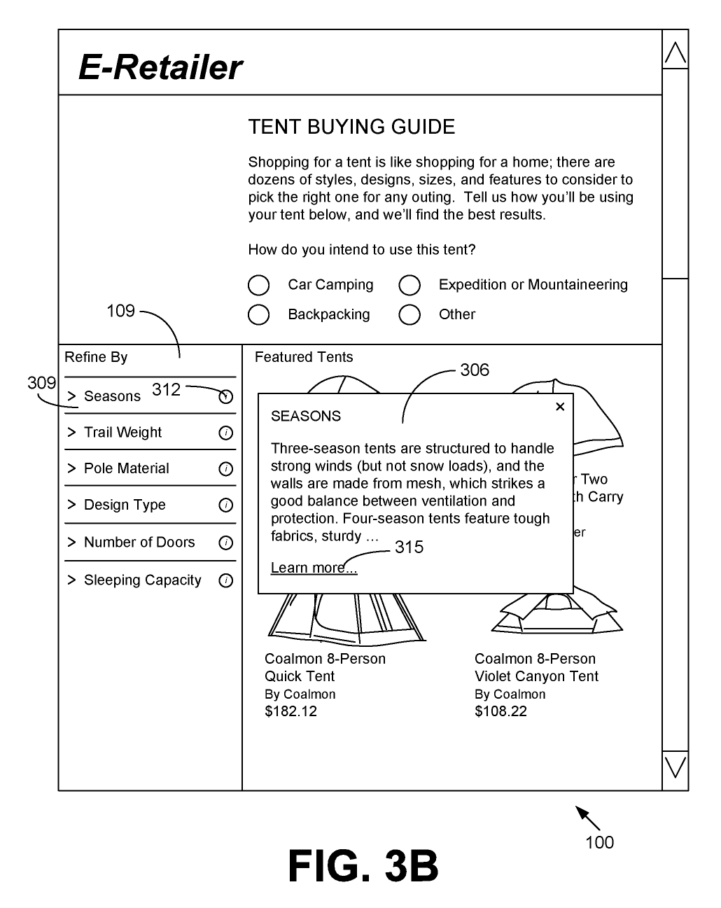

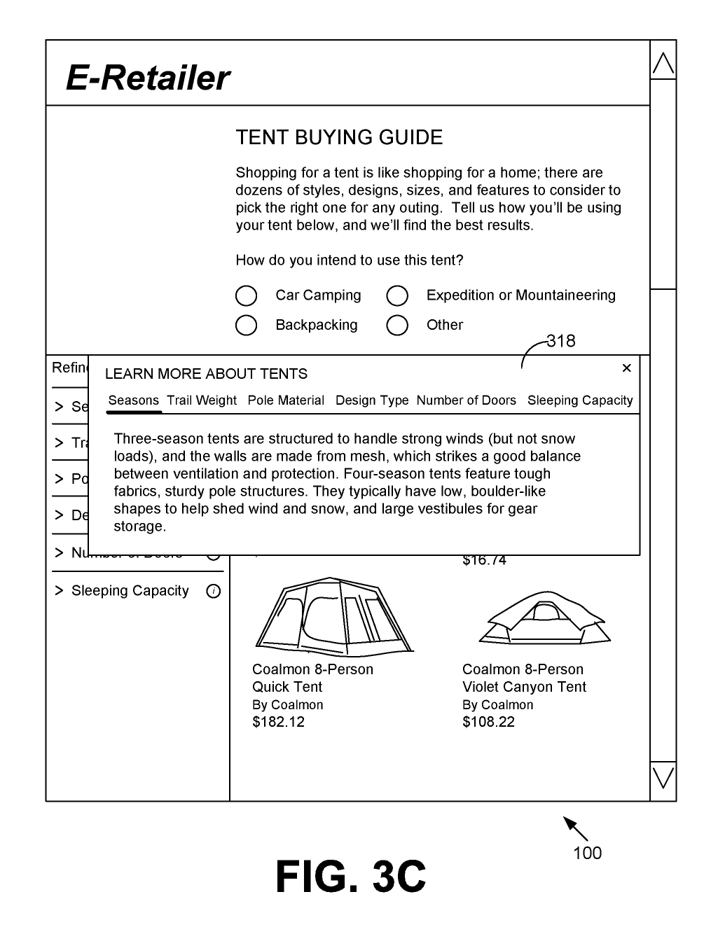

Referring next to FIG. 3A, shown is a user interface 100 rendered by a client application 254 (FIG. 2) executed in a client device 206 (FIG. 2) in the networked environment 200 (FIG. 2). The user interface 100 corresponds to the example of FIG. 1A with an explanatory dialog 300 shown relative to a user intention option 303. When a user hovers a cursor over any of the user interface components 106 (FIG. 1A) that enable selection or specification of a user intention 238 (FIG. 2), an explanatory dialog 300 may be rendered to provide an example use case or further explanation as to why a user would want to choose the particular user intention option 303.

The explanatory dialog 300 may hint at the selected refinement attributes 239 (FIG. 2) that accompany the particular user intention option 303. Here, for example, the explanatory dialog 300 for “car camping” explains, “I'm driving to a campsite. Comfort and utility are my top priorities.” This indicates that the selected refinement attributes 239 may be related to “comfort and utility.” In this example, the explanatory dialog 300 is shown as a pop-over window, but the explanatory dialog 300 may be shown using other user interface elements (e.g., modal windows, pop-up windows, and different regions of the user interface 100) in other examples.

Turning now to FIG. 3B, shown is a user interface 100 rendered by a client application 254 (FIG. 2) executed in a client device 206 (FIG. 2) in the networked environment 200 (FIG. 2). The user interface 100 corresponds to the example of FIG. 1A with an explanatory modal window 306 shown relative to a refinement tool 309 of the refinement tools 109. The refinement tool 309 allows refinement of the result set of items 224 (FIG. 2) according to a particular type of attribute 237 (FIG. 2). In this example, the attribute 237 corresponds to the season appropriateness of the tent items 224. The user may select the “>” component to expand the refinement tool 309 to see specific attribute options, which may be represented as checkboxes, drop-down boxes, radio buttons, or other user interface elements.

As part of the refinement tool 309, a component 312 allows the user to obtain further information about the refinement tool 309. When the user selects the component 312, either by active selection or hovering, the explanatory modal window 306 is shown to provide further information. The explanatory modal window 306 may be closed by the user when the user is finished. Alternatively, the user may select the component 315 to learn additional information, which may be shown in a new window or as a replacement for the user interface 100.

Continuing to FIG. 3C, shown is a user interface 100 rendered by a client application 254 (FIG. 2) executed in a client device 206 (FIG. 2) in the networked environment 200 (FIG. 2). The user interface 100 corresponds to the example of FIG. 1A with an explanatory modal window 318 shown after selecting the component 315 (FIG. 3B) to learn additional information. The explanatory modal window 318 may provide a tabbed interface with respective tab components to learn additional information about each of the categories associated with the refinement tools 109 (FIG. 1A). Videos and other rich multimedia may accompany text in order to provide detailed information. In one embodiment, the explanatory modal window 318 may be shown as a lightbox relative to the user interface 100, with the rest of the user interface 100 being grayed, dimmed, or otherwise deemphasized.

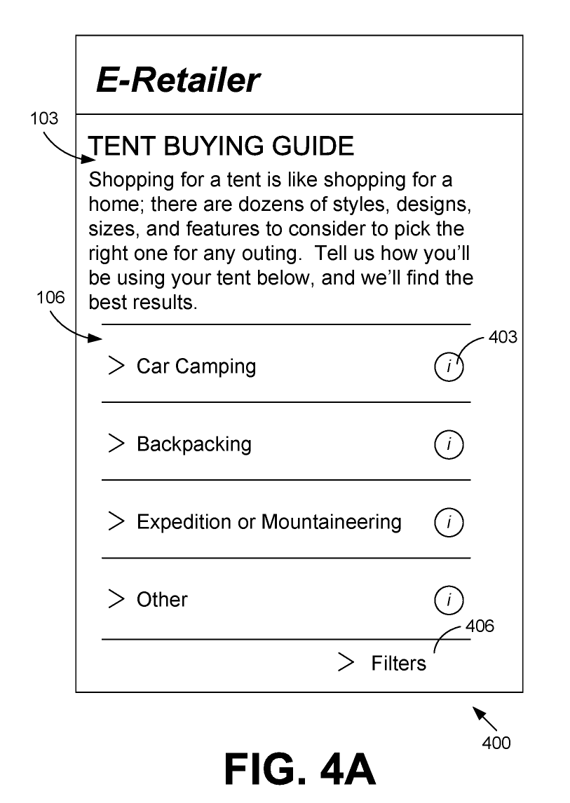

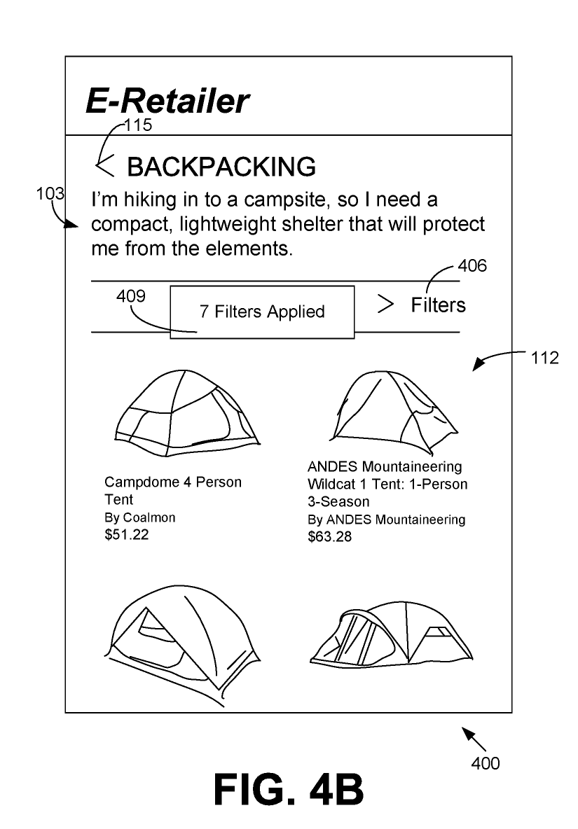

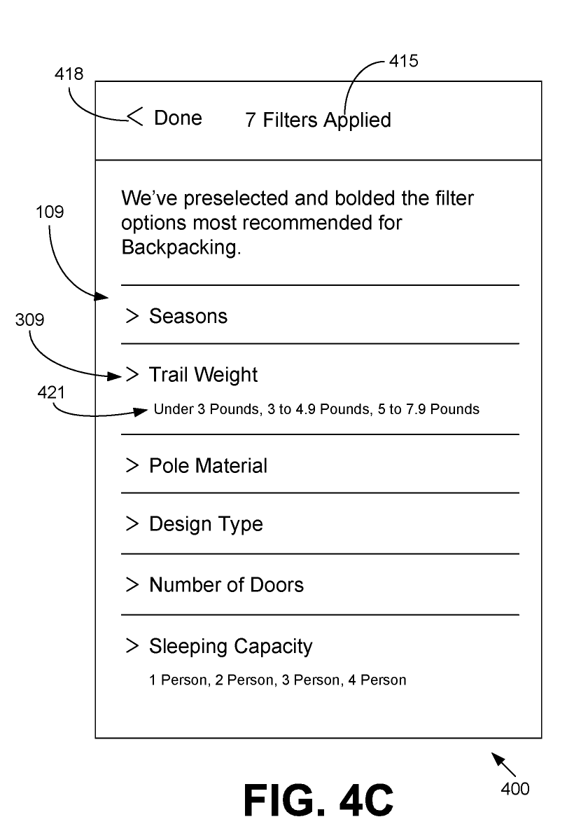

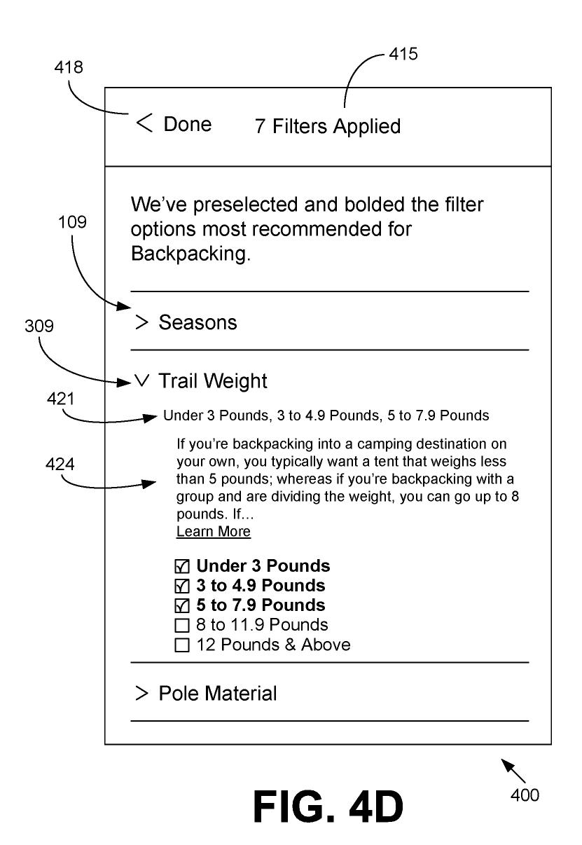

Moving on to FIG. 4A, shown is a user interface 400 rendered by a client application 254 (FIG. 2) executed in a client device 206 (FIG. 2) in the networked environment 200 (FIG. 2). The user interface 400 corresponds to the content shown in the example of the user interface 100 of FIG. 1A but rendered in an alternative format for limited-area displays 251 (FIG. 2) that are touchscreens such as with mobile devices.

In the user interface 400, the explanatory text 103 and the user interface components 106 are present, and the user may scroll or page to see an initial result set of items 224 (FIG. 2). The user may select the component 403 to see the information about the user intention presented in FIG. 3A via the explanatory dialog 300. Also, the user may select the component 406 to see a user interface that includes the refinement tools 109 (FIG. 1A), which may be referred to as filters.

Continuing to FIG. 4B, shown is another example of a user interface 400 rendered by a client application 254 (FIG. 2) executed in a client device 206 (FIG. 2) in the networked environment 200 (FIG. 2). The user interface 400 corresponds to the content shown in the example of the user interface 100 of FIG. 1B but rendered in an alternative format for limited-area displays 251 (FIG. 2) that are touchscreens such as with mobile devices. The user interface 400 of FIG. 4B includes an item display area 112 that may be scrolled or paged to see more items 224 (FIG. 2) in the result set.

The user interface 400 also includes explanatory text 103 and a back arrow 115 to return to the user interface 400 of FIG. 4A. Also, the user may select the component 406 to see a user interface that includes the refinement tools 109 (FIG. 1A), which may be referred to as filters. A user interface element 409 informs the user that a number of filters have automatically been applied to refine the result set of items 224 in response to the user's selection of an intention. The user interface element 409 may be ephemeral and shown only when the user interface 400 is first updated. The user interface element 409 may fade or become hidden a short time after rendering in one embodiment.

Referring next to FIG. 4C, shown is another example of a user interface 400 rendered by a client application 254 (FIG. 2) executed in a client device 206 (FIG. 2) in the networked environment 200 (FIG. 2). The user interface 400 of this example presents the refinement tools 109 for the user interface 400 of the example of FIG. 4B. For example, if the user were to select the component 406 in FIG. 4B, the example of FIG. 4C would be rendered. The text 415 informs the user that seven filters have been applied to the result set of items 224 (FIG. 2). The user interface 400 includes a component 418 that, when selected, returns the user interface 400 to that of FIG. 4B.

For a subset of the refinement tools 109, one or more refinement tools 309 include selected attribute information 421 informing the user which attributes in the refinement tool 309 are automatically selected. In this example, “under 3 pounds,” “3 to 4.9 pounds,” and “5 to 7.9 pounds” are automatically selected in response to the user intention of backpacking.

Turning now to FIG. 4D, shown is another example of a user interface 400 rendered by a client application 254 (FIG. 2) executed in a client device 206 (FIG. 2) in the networked environment 200 (FIG. 2). The user interface 400 of this example presents an expansion of a refinement tool 309 for the user interface 400 of the example of FIG. 4C. Additional explanatory text 424 offers more information to the user about the particular refinement tool 309 and the associated attributes that are preselected. As in the example of FIG. 1B, several attributes are preselected for the user in response to the user intention. These are shown in this example as checkboxes that are already filled in, along with bolded text adjacent to the checkboxes. It is understood that alternative user interface components (e.g., drop-down boxes, radio buttons, etc.) as well as alternative forms of emphasis (e.g., underlining, italics, all capital letters, larger font size, etc.) may be used in other embodiments.

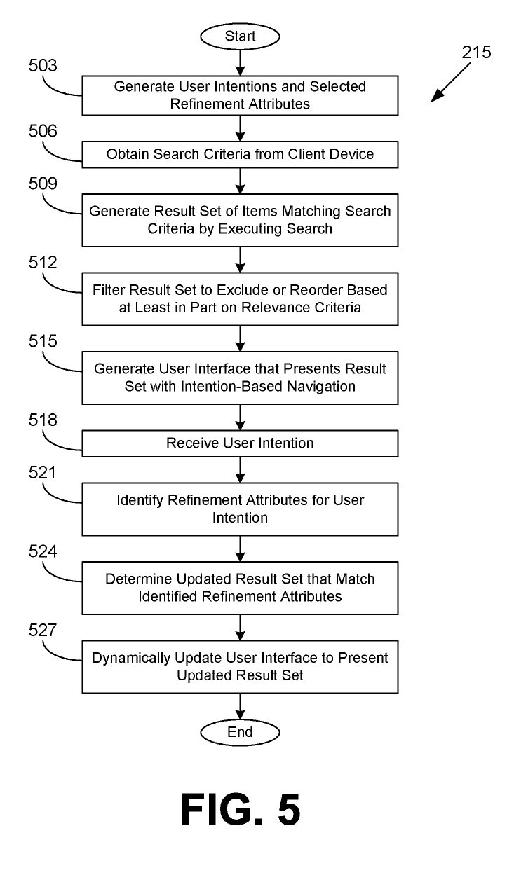

Referring next to FIG. 5, shown is a flowchart that provides one example of the operation of a portion of the item search and navigation application 215 according to various embodiments. It is understood that the flowchart of FIG. 5 provides merely an example of the many different types of functional arrangements that may be employed to implement the operation of the portion of the item search and navigation application 215 as described herein. As an alternative, the flowchart of FIG. 5 may be viewed as depicting an example of elements of a method implemented in the computing environment 203 (FIG. 2) according to one or more embodiments.

Beginning with box 503, the item search and navigation application 215 generates user intentions 238 (FIG. 2) and selected refinement attributes 239 (FIG. 2). Alternatively, the item search and navigation application 215 obtain manually curated data corresponding to user intentions 238 and selected refinement attributes 239. In one embodiment, the item search and navigation application 215 may perform an analysis on the electronic item database 221 (FIG. 2) to identify types of items 224 (FIG. 2) for which user intention-based navigation would be helpful. For example, the item search and navigation application 215 may identify types of items 224 that are associated with a number of category-specific attributes 237 (FIG. 2).

The item search and navigation application 215 may determine user intentions 238 or a plurality of item usages, for example, by analyzing feedback data 226. In this regard, the item search and navigation application 215 may extract a user intention 238 from user reviews about an item 224. If a user who buys a tent then writes a review that mentions, “I bought this tent for backpacking,” the item search and navigation application 215 may extract the user intention 238 via natural-language processing. Clustering algorithms may then be used to group the user intentions 238, and synonyms or duplicates can be removed. A threshold may be applied to remove uncommon user intentions.

Next, the selected refinement attributes 239 associated with a user intention 238 may be determined. A group of items may be determined and associated with a particular item usage based at least in part on users expressing the particular item usage in user reviews and also ordering the item 224. Once a user intention 238 is determined, a group of items 224 identified as being ordered to fulfill the user intention 238 may be examined for common item attributes 237. Again, a threshold may be applied to remove attributes 237 that exist but are not prevalent or shared among a minimum quantity of items 224.

In box 506, the item search and navigation application 215 obtains search criteria 220 (FIG. 2) from a client device 206 (FIG. 2). For example, a user may visit a network page and then enter a keyword-based search query into a search box. Alternatively, the user may visit a category page that is associated with a specific search criterion 220 (e.g., a browse node 235 (FIG. 2) in an item classification tree 234 (FIG. 2)).

In box 509, the item search and navigation application 215 generates a result set of items 224 that match the search criteria 220 by executing a search on the electronic item database 221. In box 512, the item search and navigation application 215 may filter the result set to exclude or record items 224 based at least in part on relevance criteria. In one example, items 224 having an item title exceeding a maximum length may be excluded, as such a title may reflect a poor quality item listing that is not correctly associated with attributes 237, where such attributes 237 are contained improperly in the title rather than item metadata. In another example, the result set may be filtered to exclude low-rated items 224 or items 224 that have not been ordered at least a minimum number of times.

In box 515, the item search and navigation application 215 generates a user interface 100 (FIG. 2) that presents the result set with intention-based navigation. Data encoding the user interface 100 (e.g., the search results 219) is sent to the client device 206 via the network 209 (FIG. 2) for rendering upon the display 251 (FIG. 2). The user interface 100 includes one or more user interface components 106 (FIGS. 1A & 4A) configured to elicit a user selection from among a plurality of possible user intentions 238. The user interface 100 may ask the user one or more questions, where the user intention 238 is determined from the answers to the questions. In one embodiment, a catch-all category may be shown (e.g., “other”), and the user may be prompted to enter his or her different user intention as freeform text. This user-supplied text string that corresponds to a non-predetermined user intention may be recorded and used for future analysis to identify user intentions 238.

In box 518, the item search and navigation application 215 receives or otherwise determines a user intention 238. For example, the user may select a particular radio button corresponding to a use case. The selection may be returned from the client device 206 to the item search and navigation application 215 via the network 209. In another example, the user intention 238 may be determined implicitly from context (e.g., past search queries of the user, cookie data associated with the user). In box 521, the item search and navigation application 215 identifies selected refinement attributes 239 that are associated with the specified user intention 238. In some examples, the specified user intention 238 may be associated with specific search query keywords or a specific browse node 235 (FIG. 2) in an item classification tree 234 (FIG. 2). In box 524, the item search and navigation application 215 determines an updated result set of items 224 that match the selected refinement attributes 239. This may correspond to a subset of the previous result set of items 224 or a different set of items 224. If a different set of items 224, the item search and navigation application 215 may perform the filtering operation of box 512 on this different set of items 224 as well.

In box 527, the item search and navigation application 215 causes the user interface 100 to be dynamically updated to present the updated result set. In this regard, the item search and navigation application 215 may send data encoding the updates to the user interface 100 via the network 209 to the client device 206 for rendering on the display 251. The updated user interface 100 may be configured to emphasize the attributes in the refinement tools 109 (FIGS. 1B, 4C, & 4D) that are automatically selected and enabled due to the user intention 238. The selected refinement attributes 239 are emphasized relative to refinement attributes 239 that are in a set associated with the type of item 224 but are not automatically selected and enabled. For example, the selected refinement attributes 239 may be presented with bold text and checkboxes selected, while the non-selected refinement attributes may be presented with normal text and checkboxes not selected. Thereafter, the portion of the item search and navigation application 215 ends.

The user may continue to interact with the user interface 100, including selecting different user intentions 238 or enabling or disabling various refinement attributes. While the same user intention 238 is active, the user may disable preselected refinement attributes or enable non-preselected refinement attributes. This will cause the result set of items 224 to be dynamically updated to show the items 224 that match the new combination of attributes 237. However, despite the change in selected attributes, the selected refinement attributes 239, and only those attributes, will remain emphasized in the user interface 100. Thus, the enabled non-preselected attributes will not be emphasized, and the disabled preselected attributes will remain emphasized. This serves to remind the user as to which of the attributes were automatically preselected via the user intention selection.

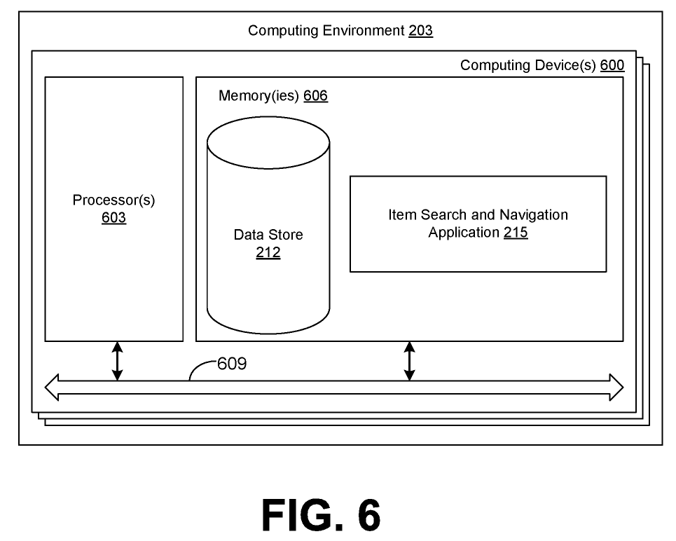

With reference to FIG. 6, shown is a schematic block diagram of the computing environment 203 according to an embodiment of the present disclosure. The computing environment 203 includes one or more computing devices 600. Each computing device 600 includes at least one processor circuit, for example, having a processor 603 and a memory 606, both of which are coupled to a local interface 609. To this end, each computing device 600 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are the item search and navigation application 215 and potentially other applications. Also stored in the memory 606 may be a data store 212 and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and/or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the item search and navigation application 215 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 5 shows the functionality and operation of an implementation of portions of the item search and navigation application 215. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowchart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the item search and navigation application 215, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the item search and navigation application 215, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 600, or in multiple computing devices 600 in the same computing environment 203.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, wherein when executed the program causes the at least one computing device to at least:
obtain a search criterion from a user;
generate a result set of items by executing a search upon an electronic item database using the search criterion;
generate a user interface that presents the result set of items, wherein the user interface includes at least one user interface component configured to elicit a user selection from a plurality of user intentions;
receive the user selection of a particular user intention of the plurality of user intentions;
identify a first subset of a set of refinement attributes corresponding to the particular user intention;
determine a first subset of the result set of items that match the first subset of the set of refinement attributes;
dynamically update the user interface to present the first subset of the result set of items in place of the result set of items, and the set of refinement attributes, wherein the first subset of the set of refinement attributes are emphasized in the user interface;
receive a user deselection of at least one of the first subset of the set of refinement attributes;
determine a second subset of the result set of items that match the first subset of the set of refinement attributes other than the at least one of the first subset of the set of refinement attributes; and
dynamically update the user interface to present the second subset of the result set of items in place of the first subset of the result set of items, and the set of refinement attributes, wherein the at least one of the first subset of the set of refinement attributes remains emphasized in the user interface despite being deselected.

2. The non-transitory computer-readable medium of claim 1, wherein when executed the program further causes the at least one computing device to at least:
receive a user selection of at least one of a second subset of the set of refinement attributes;
determine a third subset of the result set of items that match the at least one of the second subset of the set of refinement attributes and the first subset of the set of refinement attributes other than the at least one of the first subset of the set of refinement attributes; and
dynamically update the user interface to present the third subset of the result set of items in place of the first subset of the result set of items, and the set of refinement attributes, wherein the at least one of the second subset of the set of refinement attributes remains not emphasized in the user interface despite being selected.

3. The non-transitory computer-readable medium of claim 1, wherein when executed the program further causes the at least one computing device to at least:
exclude items from the result set of items that have an item title length below a threshold number of characters; and
exclude items from the result set of items that have a user feedback rating below a threshold user feedback rating.

4. A system, comprising:
at least one computing device; and
at least one application executable in the at least one computing device, wherein when executed the at least one application causes the at least one computing device to at least:
generate a user interface that presents a first result set of items from an electronic item database, wherein the user interface includes at least one user interface component configured to elicit a user selection from a plurality of user intentions;
determine a particular user intention of the plurality of user intentions;
identify a set of refinement attributes corresponding to the particular user intention;
determine a second result set of items that matches the set of refinement attributes; and
update the user interface to present the second result set of items in place of the first result set of items.

5. The system of claim 4, wherein updating the user interface further comprises including in the user interface an explanation of why the set of refinement attributes are selected relative to the particular user intention.

6. The system of claim 4, wherein when executed the at least one application further causes the at least one computing device to at least:
receive a user deselection of at least one of the set of refinement attributes;
determine a subset of the second result set of items that match the set of refinement attributes other than the at least one of the set of refinement attributes; and
update the user interface to present the subset of the second result set of items in place of the second result set of items, wherein the at least one of the set of refinement attributes remain emphasized in the user interface despite being deselected.

7. The system of claim 4, wherein when executed the at least one application further causes the at least one computing device to at least generate the first result set of items based at least in part on a keyword search query executed on the electronic item database.

8. The system of claim 4, wherein when executed the at least one application further causes the at least one computing device to at least generate the first result set of items based at least in part on items associated with a node in an item classification tree.

9. The system of claim 4, wherein when executed the at least one application further causes the at least one computing device to at least generate the first result set of items based at least in part on individual ones of the first result set of items having a minimum user rating.

10. The system of claim 4, wherein when executed the at least one application further causes the at least one computing device to at least generate the first result set of items based at least in part on individual ones of the first result set of items having a respective item title with less than a predefined character length.

11. The system of claim 4, wherein the user interface that presents the first result set of items is configured to elicit the user selection as an answer to a question concerning a user intention respecting a desired item.

12. The system of claim 4, wherein the set of refinement attributes corresponds to a subset of a set of possible refinement attributes, and the user interface is further updated to show that the set of refinement attributes are selected and other refinement attributes of the set of possible refinement attributes are not selected.

13. A method, comprising:
generating, by at least one computing device, a user interface that presents a result set of items from an electronic item database, wherein the user interface includes at least one user interface component configured to elicit a user intention regarding a desired item;
determining, by the at least one computing device, the user intention;
identifying, by the at least one computing device, a set of refinement attributes corresponding to the user intention;
determining, by the at least one computing device, a subset of the result set of items that match the set of refinement attributes; and
dynamically updating, by the at least one computing device, the user interface to present the subset of the result set of items in place of the result set of items.

14. The method of claim 13, further comprising:
receiving, by the at least one computing device, a user deselection of at least one of the set of refinement attributes; and
dynamically updating, by the at least one computing device, the user interface based at least in part on the user deselection, wherein the at least one of the set of refinement attributes remains emphasized in the user interface.

15. The method of claim 13, further comprising:
receiving, by the at least one computing device, a different user intention signifying a non-predetermined user intention; and
recording, by the at least one computing device, a user-supplied text string corresponding to the non-predetermined user intention.

16. The method of claim 13, further comprising:
receiving, by the at least one computing device, a different user intention;
identifying, by the at least one computing device, a different set of refinement attributes corresponding to the different user intention;
determining, by the at least one computing device, another subset of the result set of items that match the different set of refinement attributes; and
dynamically updating, by the at least one computing device, the user interface to present the other subset of the result set of items in place of the subset of the result set of items.

17. The method of claim 13, further comprising:
analyzing, by the at least one computing device, user reviews of the result set of items to determine a plurality of item usages of the result set of items; and
generating, by the at least one computing device, the at least one user interface component to facilitate selection of the user intention from among the plurality of item usages.

18. The method of claim 17, wherein identifying the set of refinement attributes corresponding to the user intention further comprises:
determining, by the at least one computing device, a group of items from the electronic item database that are associated with a particular item usage of the plurality of item usages; and
identifying, by the at least one computing device, the set of refinement attributes as a set of attributes shared by the group of items.

19. The method of claim 18, wherein the group of items are associated with the particular item usage based at least in part on users expressing the particular item usage and ordering individual ones of the group of items.

20. The method of claim 13, further comprising generating, by the at least one computing device, the result set of items based at least in part on a keyword search query applied to the electronic item database and a threshold criterion defining a maximum item title length or a minimum user rating.
